(19) United States
(12) Patent Application Publication
(10) Pub. No.: US 2012/0251675 A1
(43) Pub. Date: Oct. 4, 2012

(54) COATING COMPOSITION FOR FRESH PRODUCE COMPRISING CHITOSAN, SURFACTANT AND POLYETHYLENE GLYCOL

(75) Inventors: Christian Sowa, Neustadt (DE); Marcus Annawald, Schifferstadt (DE); Lenin Ovando, Cary, NC (US)

(73) Assignee: BASF SE, Ludwigshafen (DE)

(21) Appl. No.: 13/515,569

(22) PCT Filed: Dec. 13, 2010
(86) PCT No.: PCT/EP2010/069449

§ 371 Date: Jun. 13, 2012

Related U.S. Application Data
(60) Provisional application No. 61/286,823, filed on Dec. 16, 2009.

(30) Foreign Application Priority Data
Jan. 8, 2010 (EP) 10150361.3

(51) Int. Cl. A23B 7/16

(52) U.S. Cl. 426/102; 426/310; 426/532

(57) ABSTRACT

The present invention relates to a method for coating food products comprising the application of an aqueous coating composition to the surface of the food product. A further subject is said coating composition and food products coated with said coating composition.

The present invention relates to a method for coating food products comprising the application of an aqueous coating composition to the surface of the food product. A further subject is said coating composition and food products coated with said coating composition. Combinations of preferred embodiments with other preferred embodiments are within the scope of the present invention.

The greatest losses of foods, in particular of fresh fruit and vegetables, occur between harvest and consumption. Food coating is a method of keeping fruit and vegetables and processed foods fresh for longer, and also protecting them against chemical and microbial contamination and/or oxidative decay. The intention is also to protect fruit and vegetables from drying out. Contaminated foods, owing to toxic substances and bacterial and viral infections, are responsible for a considerable proportion of morbidity and mortality in the population. Oxidative changes of foods lead, inter alia, to loss of their organoleptic properties, rancidity of fats and the breakdown of essential nutrients. This adversely affects taste, aroma and color, potentially toxic lipid peroxidation products are formed and vitamins are broken down. Examples of these are the nonenzymic browning of cut fruit (apples, bananas) due to the activation of polyphenoloxidases and the oxidative breakdown of color-forming carotenoids and photooxidative changes of lipids and proteins due to the endogenous vitamin riboflavin (sun-struck flavor). In addition, mechanical stabilization of the surfaces of foods is desirable for many aspects. Cracks on the surface of the food not only impair the optical appearance, but likewise are accompanied by risk of the penetration of microorganisms. Fruit such as apples, pears and bananas is generally stored under controlled atmosphere or modified atmosphere, to increase shelf life. Treating these foods with a surface treatment composition (coating) is an alternative or supplementary technology to this by which respiration and drying and microbial decay can be decreased and thus the shelf life extended. However, successful coating of fresh fruit and vegetables is dependent on the internal gas composition, since otherwise off-flavors are formed.

Waxes were used as early as the 12th and 13th Century as the first edible coating material for fruits. Numerous other polymers capable of film formation are known as coating compositions for foods. These include, in addition to the waxes, solid fats, carbohydrates and proteins, and resins and synthetic polymers. Examples of carbohydrates are celluloses, starches, pectins, alginates, guar, carrageenan, carob bean meal, chitosan, pullulans and xanthans. Proteins which are currently used are caseinates, whey proteins, keratins, collagens, soybean protein isolates and zein. Waxes comprise beeswax, polycosanols, and carnauba wax. Shellac is the only resin which is suitable for food use. Synthetic polymers are, for example, polyethylene, polypropylene, polyvinyl acetate (PVAc), polyvinyl alcohol (PVA) or polyacrylates.

The post-harvest treatment method of food products, such as fruits and vegetables, is nowadays accomplished in industry by various machines, which are specialized for the respective type of fruit or vegetable. For example, U.S. Pat. No. 5,148,738 discloses an apparatus for chemically treating solid, debris laden food articles comprising a scrubbing station and a liquid distribution means located above said station. WO 2003/047370 discloses a produce handling machine comprising a produce washer and a sizer. U.S. Pat. No. 3,998,330 discloses an apparatus for separating objects according to size comprising a conveyor means. U.S. Pat. No. 5,806,686 discloses a sorting device for sorting selected pieces of a predetermined dimensions size from unsorted pieces. U.S. Pat. No. 4,262,477 discloses a tomato harvester comprising means for gathering tomatoes from field, shaking means and sizing means. These post-harvest methods require certain mechanical properties of the handled food product in order for reliable operations. Especially the sizing means need a high lubricity of the outer surface of the treated food for fast and reliable sizing. Currently, wax or oil are added to coatings to improve lubricity.

It is an object of the present invention to find improved coatings for coating foods, which coatings have more favorable application properties and do not lead to an impairment of the organoleptic or aesthetic properties. Another object was to find improved coating which allows reliable processing (such as sizing and coating). Further object was to achieve coated food product, especially tomatoes, which maintains firmness, has reduced shrivel and decay, reduced oily feel, and achieves consistent uniform, pink to red color. Further object was to identify coatings, which allow a fast and reliable post-harvest treatment, such as sizing.

The object was achieved by a method for coating food products comprising the application of an aqueous coating composition to the surface of the food product, wherein the coating composition comprises chitosan, acid, surfactant, and at least 5 wt % polyalkylene glycol.

Food products are all types of edible products, such as fruit (e.g. pomes, stone fruits or soft fruits), vegetables, ornamentals, dairy products, sausage and ham products, eggs or bakery products. Preferred food products are fruits or vegetables.

Suitable fruits are for example apple (e.g. ‘fuji’, ‘gala’, ‘golden delicious’, ‘granny smith’, ‘red delicious’), apricot, asian pear, avocado, banana, banana, blackberry, specialty, breadfruit, bushberries, cactus (prickly) pear, cantaloupe, cherimoya, cherry, chestnuts, date, dried fruits & nuts, durian, feijoa, figs, gooseberriy, grape, grapefruit, guava, honeydew, jackfruit, chinese jujube (chinese date), kiwifruit, lemon, lime, longan, loquat, lychee, mandarin/tangerine, mango, mangosteen, melon, cantaloupe, melon, honeydew, nectarine & peach, dried nuts & fruits, olives, orange, papaya, passion fruit, pawpaw, peach & nectarine, pear (e.g. ‘anjou’, ‘bosc,’ ‘comice’, ‘bartlett’), pepino, persimmon, pineapple, plantain, plums, pomegranate, quince, rambutan, sapotes (sapodilla, mamey sapote), starfruit (carambola), strawberry, tamarillo, tangerine/mandarin, watermelon. Preferred fruits are. apple, pear, plum, peach, cherriy, strawberry, raspberry, blackberry, gooseberry, banana, grape, mangoe, papaya, pineapple, avocado, orange, lemon, grapefruit and mandarin.

Suitable vegetables are for example artichoke, asparagus, beans, snap, belgian endive, bell pepper, broccoli, brussels sprouts, cabbage, carrots, cauliflower, celery, sweet corn, cucumber, cucurbit, eggplant, garlic, herbs, jicama, lettuce, crisphead, lettuce, romaine, mushrooms, nopalitos (cactus stems), okra, dry onions, green onions, bunching, paprika, peas, pepper, bell, potato, early crop, pumpkin & winter squash, radicchio, radish, sprouts, seed, spinach, squash, sweet potato, tomatillo (husk tomato), tomato (such as round, roma or grape tomatoes). Preferred vegetables are spinach, lettuce, asparagus, cabbage, carrot, onion, tomato potatoe, cucurbit, paprika, peppers, cucumbers and eggplant.

Suitable ornamentals are for example alstromeria, anemone, anthurium, asparagus fern, aster, baby's breath, bird of paradise, bouvardia, calla lily, carnation, chrysanthemum, daffodil, delphinium, emerald palm, eucalyptus, freesia, gerbera, ginger, gladiolus, heliconia, holly, huckleberry, iris, leatherleaf fern, lemonleaf, liatris, orchids, protea, roses, snapdragon, statice, sunflower, sweet william, sweet pea, tuberose, and yellow aster.

Food products are especially preferred tomatoes (e.g. green-mature tomatoes), peppers, melons, cucumbers and eggplant, very especially tomatoes.

The coating composition comprises at least one chitosan. Chitosan is a well known polysaccharide (Hirano, Ullmann's Encyclopedia of Industrial Chemistry, 2005, entry “Chitin and Chitosan”). The term “chitosan” relates to chitosan, chitosan derivatives and mixtures of chitosan and chitosan derivatives, preferably only to chitosan. Chitosan relates to linear β-(1→4)-linked glucosamin and N-acetylglucosamin. It may be produced from chitin or its sodium salt (e.g. originating from shrimp) by treatment with aqueous sodium hydroxide at elevated temperatures or with enzymes. Depending on the reaction conditions highly N-deacetylated or partially N-deacetylated chitosan is made. Typically, the deacetylation as determined by colloidal titration is from 50 to 99.9%, preferably from 70 to 99.8% and most preferably from 90 to 99.7%. The viscosity is usually also related to deacetylation. Typically, the viscosity of a 1 wt % chitosan solution in 1 wt % acetic acid (determined by Brookfield viscosimetry at 25° C. with a spindle at 30 rpm) is from 5 to 500 mPAs, preferably from 10 to 300 mPas. Preferred is chitosan in a purity and quality, which has GRAS status by the U.S. Food and Drug Administration.

Chitosan derivatives and their preparation are also well known (Hirano, Ullmann's Encyclopedia of Industrial Chemistry, 2005, entry “Chitin and Chitosan”; Prashanth and Tharanathan, Trends Food Sci. Technol. 2007, 18, 117-131). They are prepared by reactions at the amino group (e.g. by N-acylation, formation of N-alkylidene and N-arylidene derivatives, N-alkylation and N-arylation) or at the hydroxy groups. Preferably, chitosan derivatives are prepared by reactions at the amino group.

Typically, the coating composition comprises 0.1 to 15 wt %, preferably 0.3 to 5 wt %, and more preferably 0.5 to 3.5 wt % chitosan.

In a preferred embodiment, the method according to the invention may comprise the dilution of the coating composition with water. Typically, the coating composition is diluted with an amount of water in a ratio of water to coating composition from 1:3 to 10:1, preferably from 1:1 to 6:1, and in particular from 2:1 to 4:1. Usually, the diluted coating composition which is applied to the food, comprises 0.05 to 8 wt %, preferably 0.1 to 4 wt %, more preferably 0.2 to 3.0 wt %, and in particular 0.2 to 1.5 wt % chitosan.

The coating composition is an aqueous coating composition. Usually, the coating composition comprises at least 10 wt % water, preferably at least 40 wt %. Typically, the coating composition comprises up to 95 wt % water, preferably up to 85 wt %, and more preferably up to 75 wt %.

The coating composition comprises at least one acid. Suitable acids include organic or inorganic acids. Preferred are organic acids. Suitable organic acids include acetic acid, citric acid, lactic acid, malic acid, propionic acid and succinic acid. Preferably, the acid is acetic acid. The acid may be added in form of an aqueous solution in various concentrations. Usually, the amount of added acid depends on the pH value which is desired in the coating composition.

The concentration of the acid relates to the pure acid, even when a aqueous solution of acid is used. Preferably, the concentration of acid depends on the desired pH value of the aqueous coating composition, which is from pH 3.5 to 7.0. preferably from 4.5 to 6.0, more preferably from 5.0 to 5.6. Thus, the concentration of the acid is usually adjusted to said desired pH. Typically, the coating composition comprises 0.01 to 5 wt % acid (such as acetic acid), preferably 0.1 to 3 wt %, more preferred 0.3 to 2.0 wt %.

The coating composition comprises at least one polyalkylene glycol. Polyalkylene glycol are polymers comprising alkylene glycol monomer units (e.g. polyethylene glycol comprises ethylene glycol monomer units). Suitable polyalkylene glycols may have a free hydroxyl group at each end of the polymer molecule, or may have one or more hydroxyl groups etherified with a C₁ to C₁₈ alkyl (preferably a methyl group). Also suitable are derivatives of polyethylene glycols having esterifiable carboxy groups. Suitable polyalkylene glycols are also statistical or block-like copolymers made of at least two different alkylene glycol monomer units. Examples of block-like copolymers of polyalkylene glycol arepolyethylene glycol-polypropylene glycol-blockcopolymers. The blockcopolymers may be of AB or ABA type.

Preferred polyalkylene glycols are polyethylene glycol, polypropylene glycol, polytetrahydrofurane or polybutylene glycols. More preferably, the polyalkylene glycol is polyethylene glycol or polypropylene glycol. Suitable polyethylene glycols are commercially available, such as Carbowax™ and Carbowax™ Sentry series (available from Dow), the Lipoxol™ series (available from Brenntag), the Lutrol™ series (available from BASF), and the Pluriol™ series (available from B ASF).

In a preferred embodiment, the polyalkylene glycol has a melting point below 50° C., more preferably below 40° C., most preferably below 30° C.

In another preferred embodiment, the polyalkylene glycol has viscosity at 50° C. of up to 200 mm²/s, preferably up to 100 mm²/s, and more preferably up to 50 mm²/s. The viscosity may be determined by the method as described in DIN 51562.

Usually, the polyalkylene glycol has an average molecular weight in the range from 150 to 20000 g/mol, preferably from 150 to 5.000 g/mol, more preferably from 150 to 1000 g/mol and most preferably from 180 to 650 g/mol. The molecular weight corresponds to an average molecular weight of this polymer. It may be calculated based on the hydroxyl number according to DIN 53240).

The coating composition comprises at least 5 wt %, preferably at least 10 wt %, more preferably at least 13 wt %, even more preferably at least 15 wt %, and most preferably at least 18 wt %, polyalkylene glycol. Preferably the coating composition comprises up to 65 wt %, more preferably up to 55 wt %, and most preferably up to 45 wt % of polyalkylene glycol. In another preferred embodiment, the coating composition comprises from 5 to 65 wt %, preferably from 12 to 55, more preferably from 15 to 55 wt %, and especially preferred from 18 to 43 wt % of polyethylene glycol. The aforementioned wt % of polyalkylene glycol are based on the total weight of the coating composition.

The coating composition comprises at least one surfactant. Suitable surfactants are anionic, cationic, nonionic and amphoteric surfactants, block polymers and polyelectrolytes. Mixtures of surfactants are also suitable. Preferred surfactants are nonionic surfactants, especially sugar-based surfactants, such as ethoxylated sorbitans.

Suitable anionic surfactants are alkali, alkaline earth or ammonium salts of sulfonates, sulfates, phosphates or carboxylates. Examples of sulfonates are alkylarylsulfonates, diphenylsulfonates, alpha-olefin sulfonates, sulfonates of fatty acids and oils, sulfonates of ethoxylated alkylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates and carboxylated alcohol or alkylphenol ethoxylates.

Examples of suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide or of the A-B-C type comprising alkanol, polyethylene oxide and polypropylene oxide. Suitable polyelectrolytes are polyacids or polybases. Examples of polyacids are alkali salts of polyacrylic acid. Examples of polybases are polyvinylamines or polyethyleneamines.

Suitable nonionic surfactants are alkoxylates, N-alkylated fatty acid amides, amine oxides, esters or sugar-based surfactants. Examples of alkoxylates are compounds such as alcohols, alkylphenols, amines, amides, arylphenols, fatty acids or fatty acid esters which have been alkoxylated. Ethylene oxide and/or propylene oxide may be employed for the alkoxylation, preferably ethylene oxide. Examples of N-alkylated fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides.

Preferred surfactants are sugar-based surfactants, such as sorbitans and ethoxylated sorbitans. Sorbitans are monoanhydrosorbites and their derivatives, such as ethers and esters. Preferred sorbitans are fatty acid esters of sorbitans (such as sorbitan monooleate, monolaurate or monostearate) and, preferably, the ethoxylated fatty acid esters of sorbitans. Preferably, the ethoxylated sorbitans comprise 10 to 200 moles (preferably 15 to 100 moles) of ethylene oxide per mol sorbitan.

The coating composition may comprise at least 0.1 wt % surfactant. The concentration relates to the sum of all surfactants present in the composition. Preferably, the coating composition comprises at least 0.5 wt %, more preferably at least 1.0 wt %, most preferred at least 2.0 and especially preferred at least 5 wt % surfactant, such as sugar-based surfactants. The coating composition may comprise up to 30 wt %, preferably up to 15 wt % surfactant. In another preferred embodiment, the coating composition comprises from 0.1 to 30 wt % surfactant, more preferably from 1.0 to 20 wt % and most preferably from 5 to 15 wt %.

The coating composition may comprise further additives, such as antioxidants, disinfectants, film forming synthetic polymers, antisprouting agents, antifoams or preservatives.

Examples of antifoams are silicone emulsions (such as, for example Silikon® SRE, Wacker, Germany or Rhodorsil®, Rhodia, France), long-chain alcohols, fatty acids, salts of fatty acids, organofluorine compounds and their mixtures.

Suitable preservatives are for example methylparaben, ethylparaben, propylparaben, butylparaben, sodium propionate, calcium propionate, benzoic acid sodium benzoate, potassium sorbate and sodium bisulfite.

Examples of antioxidants are ascorbic acid and salts thereof, isoascorbic acid and salts thereof, ascorbyl palmitate and ascorbyl stearate, butylated hydroxytoluene, butylated hydroxyanisole, ethoxyquin, nordihydroguaiaretic acid and salts thereof, isopropyl citrate, gallic acid esters, tocopherols, compounds having an SH structure, for example cysteine, N-acetylcysteine, sulfites, antioxidant extracts, for example rosemary extract.

Examples of disinfectants are peroxides, such as hydrogen peroxide or benzoyl peroxide. They are usually applied in an amount of 0.01 to 5 wt %, preferably from 0.05 to 1 wt %.

Suitable film forming synthetic polymers are usually polymers based on ethylenically unsaturated monomers. Preferred film forming synthetic polymers are polyethylene, polypropylene, poly(N-vinylpyrrolidon), polypolyvinyl acetate (PVAc; such as described in U.S. Pat. No. 3,262,785), polyvinyl alcohol (PVA; such as described in U.S. Pat. No. 66,165,529), polyacrylates or polyvinylalcohol-polyether graft copolymer (such as described in WO 2005/055741.

Examples of antisprouting agents are chlropropham, propham or carvone.

The coating composition according to the invention provides a coating with excellent lubricity. Thus, the coating composition does not require the addition of oils and waxes like many other coating compositions for food products. Examples of oils for food coating are paraffin oil, mineral oil, castor oil, lard oil, tallow, rapeseed oil, vegetables oils (canola, peanut, corn or soy). Examples of waxes are paraffin, carnauba, beeswax, cadellilla and polyethylenene wax. Such commercially available coating compositions, which are based on oils and/or waxes are often applied neatly, i.e. as 100% products. Wax based products often need to be molten prior to application. Such hydrophobic compounds like oils and waxes are therefore usually not compatible with aqueous solutions, such as chitosan based coating composition. Typically, the coating composition according to the invention comprises less than 50 wt %, preferably less than 30 wt %, more preferably less than 10 wt % and especially less than 1 wt % oils and wax.

The method according to the invention is especially useful in the post-harvest treatment of fruits and vegetables. These post-harvest methods require certain mechanical properties of the handled food product in order for reliable operations. Thus, the present method is especially suitable in connection with subsequent sizing means. Sizing is a very important step in food processing since many years (Sargent et al., Applied Eng. Agriculture, 1991 7(6) 724-728).

The inventive coating composition can be applied by various processes, for example by dipping the food product in a tank or vat of the coating composition, by spraying the coating composition onto the food product, by fogging, by fine mist, or by passing the food product through a downwardly falling curtain or waterfall of the coating composition, or knife-coating. Preferably, it is applied by dipping or spraying, especially spraying. Additionally, the food product may be dried afterwards, e.g. by feeding warm air, by microwave radiation or by infrared radiation. During the drying process, the aqueous coating composition forms a dry coating composition on the surface of the food product. The entire coating process can be designed to be batchwise or continuous.

The coating composition is applied to the surface of the food product. The surface is usually the outer sphere of a food product. The surface includes the surface of the original food product (e.g. the fruits and vegetables as grown on the field) and the surface of the processed food product (e.g. after removing debris or after slicing). After application of the aqueous coating composition to the surface, said composition forms a coating layer on the surface, especially after drying the food product.

The layer thicknesses of the coating (as determined of the dry coating), depending on the food product and function of the coating, can be from 0.2 to 200 μm, preferably from 1 to 75 μm. The film thickness may be controlled in this case via the concentration of the solution applied.

Food products coated with the coating composition according to the invention can, for sterilization without further pretreatment, be irradiated or exposed to a controlled atmosphere. In addition, the foods can be thermally pretreated.

While not intending to be bound by any particular theory, it is considered that coating with the composition of the present invention limits but does not prevent respiratory exchange, i.e., transmission of oxygen (air) into the produce, transmission of gases, e.g., ethylene and carbon dioxide, out of the produce, and water vapor transmission.

This may prolong maturation and ripening process and, in turn, to increase the permissible storage time between harvest and consumption.

The present invention also relates to an aqueous coating composition which comprises chitosan, acid, surfactant, and at least 5 wt % polyalkylene glycol. Suitable and preferred embodiments of the components of said coating composition are described above.

Preferably, the coating composition according to the invention comprises
0.1 to 15 wt % chitosan,
0.01 to 5 wt % acid,
0.1 to 30 wt % surfactant,
5 to 65 wt % polyalkylene glycol, and
up to 95 wt % water.

More preferably, the coating composition according to the invention comprises
0.3 to 5 wt % chitosan,
0.1 to 3 wt % acid,
1.0 to 20 wt % surfactant,
10 to 55 wt % polyalkylene glycol, and
up to 85 wt % water.

Most preferably, the coating composition according to the invention comprises
0.5 to 3.5 wt % chitosan,
0.3 to 2 wt % acid,
5 to 15 wt % surfactant,
18 to 43 wt % polyalkylene glycol, and
up to 75 wt % water.

The present invention also relates to a food product coated with the coating composition according to the invention. The food product may be coated with the method according to the invention. Suitable and preferred embodiments of food products are described above.

The present invention offers several advantages: The conventional requirement for refrigeration may either be eliminated or significantly reduced thus making the method and the composition economical. The cost savings achieved by reduced refrigeration requirements and reduced deterioration losses may cover or exceed the cost of the additional processing required when the ripening process is initiated. The coated food product has excellent processing stability in post-harvest processing means. Due to the high lubricity a fast and reliable processing (especially sizing) is possible of the coated food products, such as tomatoes. Hardly any addition of oils or waxes is required to achieve high lubricity. This is very helpful for continuous processing, because oils or waxes result in sticky depositions on the equipment (especially the sizing equipment and packaging lines). Such sticky deposition result in costly processing interruptions for cleaning the equipment.

The faster advancement of green to red coloration on “green-mature” tomatoes allows to shorten up to a day of ethylene gassing time (which is usually a bottleneck of operation for these type of tomatoes), resulting in a more efficient packing operation overall. The more uniform coloration of tomatoes during ethylene gassing (green to pink or red) allows for certain types of tomatoes (i.e. Roma or Saladette tomatoes) which are often times re-run in a packing line after gassing, to be shipped right away without re-running or re-grading for color a second time. This results in considerable time and labor savings. Another advantage is the “healing” of open wounds inflicted during harvest and packing (bruises, nail wounds, etc) and prevention of “nesting” or expansion of fungi within packed produce resulting in lower decay and better quality grading at the repacking operations at the destination cities. The maintenance of firmness is an advantage for the food service processor for better handling of sliced and diced tomatoes. In addition, greenhouse-grown tomatoes marketed with the stems remained their green stems longer green.

Further on, grapes showed lower botrytis incidence and maintenance of green stems. This is might be a replacement of SO₂ pads against botrytis with the added benefit of their green stems beeing longer green.

The invention is further illustrated but not limited by the following examples.

### EXAMPLES

### Example 1

### Preparation of Coating Compositions

To an initial amount of warm water the nonionic surfactant B (ethoxylated sorbitan fatty acid ester), defoamer and preservative were added. After the components were dissolved, chitosan (poly-D-glucoseamine, white powder, soluble in water below pH 5.7) and acetic acid were added. After cooling down to ambient temperature polyethylene glycol (average molecular weight 400 g/mol) and nonionic surfactant A (ethoxylated sorbitan fatty acid ester) were added while stirring. Finally, the mixture was filled up with water to a volume of 1000 ml under stirring. The amounts of the components are summarized in Table 1. The comparative coating composition (“Comparative”, not according to the invention) in Table 1 comprised additionally an aqueous wax emulsion (carnauba wax, 25 wt % solid content).

TABLE 1
Compositions (all values in gramm)

| | A | B | C | D | E | F | Comparative |
|---|---|---|---|---|---|---|---|
| Chitosan | 19.5 | 19.5 | 25.0 | 30.0 | 25.0 | 30.0 | 19.5 |
| Acetic acid | 5.8 | 5.8 | 7.3 | 8.7 | 7.3 | 8.7 | 5.8 |
| Polyethylene | 300.0 | 240.0 | 350.0 | 420.0 | 275.0 | 360.0 | — |
| glycol | | | | | | | |
| Noninionic | 20.0 | 80.0 | 25.0 | 30.0 | 100.0 | 120.0 | — |
| Surfactant A | | | | | | | |
| Noninionic | 1.2 | 1.2 | 1.5 | 1.8 | 1.5 | 1.8 | 1.2 |
| Surfactant B | | | | | | | |
| Defoamer | 0.2 | 0.2 | 0.3 | 0.3 | 0.3 | 0.3 | 0.2 |
| Preservative | 2.0 | 2.0 | 2.5 | 3.0 | 2.5 | 3.0 | 2.0 |
| Wax emulsion | — | — | — | — | — | — | 15.6 |
| Water | 705.3 | 700.3 | 640.0 | 560.0 | 640.0 | 530.0 | 955.0 |
| Total weight | 1054.0 | 1049.0 | 1051.6 | 1053.8 | 1051.6 | 1053.8 | 999.3 |

### Example 2

### Delay of Decay and Shrivel of Tomatoes

Four batches of each about 40 tomatoes were treated with the coating formulations A, B and Comparative (each diluted with water to a final chitosan concentration of 0.5 wt %) and stored at 20° C. (68 F) for four days. About 15 to 18 ml of an aqueous coating solution was used to uniformly coat 25 lbs (11.3 kg) of tomates. Then they were stored in the dark at 13° C. (55 F). The storage results are given in Table 2.

Six days after coating the fruit maturity was measured as aggregate percentage of tomatoes that were pink, light red or red (“color”).

Thirteen days and 22 days after coating the decay was analyzed visually to detect if any symptoms for decay exists or not. The percentage of tomatoes with decay symptons is given in Table 2. Additionally, 22 days after coating the percentage of shrivel was analyzed visually to detect if any shrivel exists or not. The percentage of tomatoes with shrivel is given in Table 2.

TABLE 2
Percent of tomatoes

| | Color | Decayed | Decayed | Shriveled |
|---|---|---|---|---|
| | [%] | (13 days) [%] | (22 days) [%] | (22 days) [%] |
| Comparative^{a)} | 84.2 | 5.1 | 13.4 | 2.6 |
| A | 87.7 | 1.2 | 13.2 | 0 |
| B | 88.5 | 1.7 | 9.3 | 1.7 |

^{a)}not according to the invention

In a second experiment, four batches of each about 40 tomatoes were treated and stored as described as described above. The fruit maturity was determined 4 and 7 days after coating. The decay was determined 14, 18 and 21 after coating (Table 3).

TABLE 3
Percent of tomatoes

| | Color | Color | Decayed | Decayed | Decayed |
|---|---|---|---|---|---|
| | (4 days) | (7 days) | (14 days) | (18 days) | (21 days) |
| | [%] | [%] | [%] | [%] | [%] |
| Comparative^{a)} | 32 | 78.7 | 9.3 | 14.7 | 34.7 |
| A | 27 | 73.3 | 10.7 | 14.7 | 30.7 |
| B | 34 | 77.6 | 6.7 | 9.4 | 28.4 |

^{a)}not according to the invention

In conclusion, the inventive coating formulations reduced the decay and increased the color development, while maintaining the firmness (as shown by the lower shriveling) With regard to the delay of decay and fruit maturity, the formulations are as good as formulations of the state of the art.

### Example 3

### Lubricity

The lubricity of various coating compositions was analyzed on a rheometer (rotational cylinder type). The composition was placed on the lower metal plate. The upper metal plate is rotated at a speed of 100 rpm at 20° C. at a certain gap width. The torque was determined at a gap width of 20 μm (Table 4). For comparison, a commercially available carnauba wax emulsion was used (aqueous carnauba wax emulsion comprising 12 wt % carnauba wax, <10 wt % shellac, <10 wt % anionic emulsifier, pH 9-11).

TABLE 4

| Coating composition | Torque [μNm] |
|---|---|
| Carnauba wax^{a)} | 420 |
| B | 115 |
| E | 110 |

^{a)}not according to the invention.

1-16. (canceled)

17. A method for coating a food product comprising applying an aqueous coating composition to the surface of the food product, wherein the aqueous coating composition comprises chitosan, an acid, a surfactant, and at least 5 wt % polyalkylene glycol, and wherein the food product is a fruit or a vegetable.

18. The method of claim 17, wherein the aqueous coating composition is applied post-harvest.

19. The method of claim 17, wherein the fruit is apple, pear, plum, peach, cherry, strawberry, raspberry, blackberry, gooseberry, banana, grape, mango, papaya, pineapple, avocado, orange, lemon, grapefruit or mandarin, and wherein the vegetable is spinach, lettuce, asparagus, cabbage, carrot, onion, tomato, potato, cucurbit, paprika, peppers, cucumbers or eggplant.

20. The method of claim 17, wherein the aqueous coating composition comprises 0.1 to 5 wt % chitosan.

21. The method of claim 17, wherein the aqueous coating composition comprises at least 10 wt % polyalkylene glycol.

22. The method of claim 17, wherein the polyalkylene glycol has an average molecular weight in the range from 150 to 20000 g/mol.

23. The method of claim 17, wherein the polyalkylene glycol has a melting point below 50° C.

24. The method of claim 17, wherein the polyalkylene glycol is polyethylene glycol or polypropylene glycol.

25. The method of claim 17, wherein the acid is an organic acid.

26. The method of claim 17, wherein the aqueous coating composition comprises at least 0.1 wt % surfactant.

27. The method of claim 17, wherein the surfactant is a nonionic surfactant.

28. The method of claim 17, wherein the aqueous coating composition comprises less than 1.0 wt % oil and wax.

29. The method of claim 17, wherein the aqueous coating composition comprises 0.1 to 15 wt % chitosan, 0.01 to 5 wt % acid, 0.1 to 30 wt % surfactant, 5 to 65 wt % polyalkylene glycol, and up to 95 wt % water.

30. A food product coating composition comprising chitosan, an acid, a surfactant, and at least 5 wt % polyalkylene glycol.

31. The coating composition of claim 30, wherein the coating composition comprises 0.1 to 5 wt % chitosan.

32. The coating composition of claim 30, wherein the coating composition comprises at least 10 wt % polyalkylene glycol.

33. The coating composition of claim 30, wherein the polyalkylene glycol has an average molecular weight in the range from 150 to 20000 g/mol.

34. A food product coated with the food product coating composition of claim 30, wherein the food product is a fruit or a vegetable.

35. The food product according to claim 30, wherein the fruit is apple, pear, plum, peach, cherry, strawberry, raspberry, blackberry, gooseberry, banana, grape, mango, papaya, pineapple, avocado, orange, lemon, grapefruit or mandarin, and wherein the vegetable is spinach, lettuce, asparagus, cabbage, carrot, onion, tomato, potato, cucurbit, paprika, peppers, cucumbers or eggplant.
